(19) United States
(12) Patent Application Publication
(10) Pub. No.: US 2002/0163589 A1
(43) Pub. Date: Nov. 7, 2002

(54) Solid-state image pickup device and method of producing the same

(76) Inventors: Masahiko Yukawa, Kanagawa (JP); Mutsumi Nagano, Kanagawa (JP); Atsushi Kashiwazaki, Aichi (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/082,836

(22) Filed: Feb. 25, 2002

(30) Foreign Application Priority Data
Feb. 26, 2001 (JP) P2001-050435

(51) Int. Cl. H04N 5/225

(52) U.S. Cl. 348/374

(57) ABSTRACT

A solid-state image pickup device including a circuit board with an opening, a solid-state image pickup element including a light-receiving surface, a sensor package which accommodates the light-receiving surface and the solid-state image pickup element, and an optical unit including a lens. The solid-state image pickup element, the sensor package, and the optical unit are mounted to the circuit board. In the solid-state image pickup device, the sensor package and the optical unit are disposed so that there is provided an optical path that allows light incident upon the lens to pass the opening and to reach the light-receiving surface at a surface side. By mounting the component parts onto both surfaces, the area of the circuit board can be effectively used, and the size of the solid-state image pickup device in the horizontal direction of the circuit board can be reduced. The optical unit is mounted to the circuit board. Therefore, even if a fast lens with a large diameter is used, the opening of the circuit board does not need to be made large, so that the size of the lens can be changed without increasing the size of the solid-state image pickup device. Accordingly, the invention provides a solid-state image pickup device which makes it possible to change the size of the lens.

### BACKGROUND OF THE INVENTION

1. Field of the Invention

The present invention relates to a solid-state image pickup device and a method of producing the same. More particularly, the present invention relates to a solid-state image pickup device including a solid-state image pickup element, such as a CCD (charge-coupled device) type or a CMOS (complementary metal oxide semiconductor) type, and a method of producing the same.

2. Description of the Related Art

Smaller, thinner electronic devices to whose portability importance is attached are causing a demand for smaller electronic parts that are installed therein. In recent years, in particular, small image input devices are beginning to be widely used, so that there is a demand for image pickup devices that are installed in these image input devices to be small and to have high performance, such as high functionality and low power consumption.

In general, a CCD or a CMOS solid-state image pickup element is installed in an image pickup device. A high-performance solid-state image pickup element is being developed by improving, for example, a technology for producing a finer solid-state image pickup element or a technology for producing a more highly integrated solid-state image pickup element. In addition, an attempt is being made to reduce the size of electronic devices that incorporate solid-state image pickup devices by, using a high-level mounting technology, reducing the thickness and width of an entire solid-state image pickup device that incorporates a solid-state image pickup element. For example, Japanese Unexamined Patent Application Publication Nos. 11-191865 and 11-354769 disclose an attempt to reduce the size of a solid-state image pickup device using a circuit board having an opening.

FIG. 3 illustrates an example of a related downsized solid-state image pickup element.

In a solid-state image pickup device 100, a method of securing a solid-state image pickup element unit 104 to a circuit board 106 having an opening 105 by inserting the whole solid-state image pickup element unit 104 into the opening 105 so that an optical axis of the solid-state image pickup element unit 104 is at right angles to the circuit board 106 is used. The solid-state image pickup unit 104 comprises a solid-state image pickup element 102 having a light-receiving surface 101, wiring means (not shown) for transmitting an input/output signal of the solid-state image pickup element 102, a lens 103 for focusing light that is incident upon the solid-state image pickup element 102, and an optical filter (not shown).

Since the solid-state image pickup element unit 104 is secured by inserting it into the opening 105 of the circuit board 106, the maximum thickness of the solid-state image pickup device 100 is reduced in size by an amount corresponding to the thickness of the circuit board 106 compared to when the solid-state image pickup element unit 104 is mounted onto the circuit board 106.

FIG. 4 illustrates another example of a related downsized solid-state image pickup element.

A solid-state image pickup device 200 is constructed so that a solid-state image pickup element 204 having a light-receiving surface 203 is connected to one surface of a circuit board 202 having an opening 201, and so that an optical unit 206 is provided at the other surface of the circuit board 202. The optical unit 206 includes an optical filter (not shown) and a lens 205 for focusing light that is incident upon the solid-state image pickup element 204.

In constructing the solid-state image pickup device 200, the solid-state image pickup element 204 and the optical unit 206 are disposed on both sides of the circuit board 202. When connecting the solid-state image pickup element 204 to the circuit board 202, a gold plated pad is used for the connection; contamination of the light-receiving surface 203 by flux, such as that which occurs when solder is used for a joining operation, is prevented from occurring; and, by improving and selecting a circuit board material, an attempt is made to prevent adherence of foreign matter onto the light-receiving surface 203 caused by, for example, chips that are produced when cutting the circuit board during the production process.

However, in the method in which the related solid-state image pickup unit is secured by inserting it into the opening of the circuit board, since the solid-state image pickup element unit is secured by inserting it into the opening of the circuit board, the size of the solid-state image pickup element unit in the horizontal direction of the circuit board must obviously be smaller than the opening. Therefore, when a large lens is used, the size of the opening of the circuit board must be made large in accordance with the size of the lens.

The larger the diameter of the lens used in the solid-state image pickup device is, the larger the amount of light incident upon the lens and, thus, the faster the lens. Therefore, a lens with a large diameter can provide a nice image. Accordingly, since, for example, a fast lens is preferred, a lens having a large diameter is increasingly being used. As the diameter of the lens increases, the entire lens obviously becomes large. As the entire lens becomes large, the solid-state image pickup element unit becomes large, so that the opening in the circuit board must be made large. As a result, the problem of the solid-state image pickup device becoming large in the horizontal direction of the circuit board arises.

When the solid-state image pickup element is directly connected to the circuit board, the solid-state image pickup element unit that has been mounted becomes thin. However, the solid-state image pickup element and the optical unit are separately mounted to the circuit board. Therefore, handling of the solid-state image pickup element, particularly the light-receiving surface of the solid-state image pickup element, during the step of connecting the solid-state image pickup element to the circuit board may become complicated. When dust or dirt sticks onto the light-receiving surface, this dust or dirt appears as a shadow when an image is projected. Therefore, it is not preferable for dust or dirt to stick onto the light-receiving surface. Alternatively, when moisture sticks onto the light-receiving surface, the moisture also appears as a shadow when an image is projected. Therefore, it is not preferable for moisture to stick onto the light-receiving surface. Consequently, in order to connect the solid-state image pickup element directly to the circuit board, dirt or dust must not be produced when the step is carried out, and a circuit board material that does not produce foreign matter, such as chips, must be selected.

### SUMMARY OF THE INVENTION

In view of the above-described problems, it is an object of the present invention to provide a solid-state image pickup device which makes it possible to change the size of a lens without increasing the area of a circuit board and which can be easily handled. It is also an object of the present invention to provide a method of producing the same.

To these ends, according to one aspect of the present invention, there is provided a solid-state image pickup device comprising a circuit board having an opening; a sensor package, disposed at one surface of the circuit board so that a light-receiving surface of a solid-state image pickup element opposes the opening, for sealing in the solid-state image pickup element; and an optical unit disposed at the other surface of the circuit board so that incident light is focused on the light-receiving surface.

According to another aspect of the present invention, there is provided a method of producing a solid-state image pickup device comprising the step of providing a circuit board with an opening; the step of joining a sensor package, in which a solid-state image pickup element has been previously sealed, to one surface of the circuit board so that a light-receiving surface of the solid-state image pickup element opposes the opening; and the step of disposing and joining an optical unit at and to the other surface of the circuit board so that incident light is focused on the light-receiving surface.

According to the first and second aspects of the present invention, since the solid-state image pickup element is accommodated in the sensor package, the solid-state image pickup element is protected from outside air. Therefore, for example, the problems of dirt, dust, and moisture sticking onto and condensation of penetrated moisture at the solid-state image pickup element and the light-receiving surface of the solid-state image pickup element do not arise. In addition, since the sensor package that accommodates the solid-state image pickup element is connected to the circuit board, the solid-state image pickup device is not troublesome to handle during the production process steps.

According to the first and second aspects of the present invention, an opening is formed in the circuit board, the sensor package is disposed at one surface of the circuit board by aligning the light-receiving surface with the opening, and the optical unit is disposed at the other surface of the circuit board, at a location where a focused light is incident upon the light-receiving surface. Therefore, the sensor package and the optical unit are disposed at one surface and the other surface of the circuit board, respectively, and, by the opening formed in the portion of the circuit board where the sensor package and the optical unit are disposed, a path that allows external incident light to pass the optical unit and to reach the light-receiving surface inside the sensor package is provided.

Since the sensor package and the optical unit are disposed on one surface and the other surface of the circuit board, respectively, and both surfaces of the circuit board are used for mounting parts, it is possible to reduce a projection area of the circuit board.

Since the optical unit is mounted to the circuit board, the size of the optical unit can be changed independently of the size of the sensor package. Therefore, even when a lens with a large diameter is used, the size of the opening of the circuit board does not need to be made large.

### BRIEF DESCRIPTION OF THE DRAWINGS

FIG. 1 is a sectional view of a solid-state image pickup device of an embodiment of the present invention.

FIG. 2 is a sectional view of a solid-state image pickup element when a signal processing circuit is accommodated in a sensor package.

FIG. 3 illustrates an example of a related downsized solid-state image pickup element.

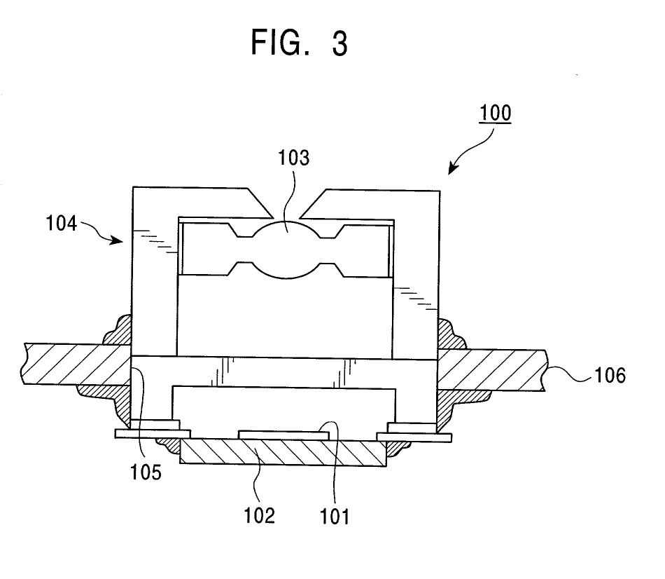

FIG. 4 illustrates another example of a related downsized solid-state image pickup element.

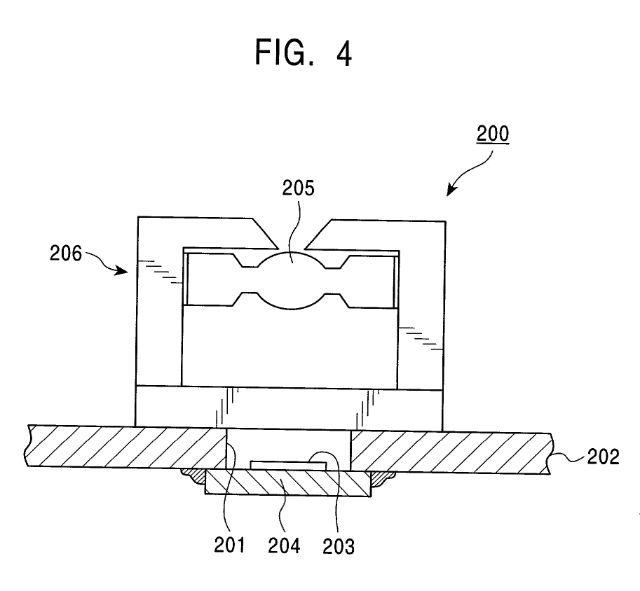

### DESCRIPTION OF THE PREFERRED EMBODIMENT

Hereunder, a description of an embodiment of the present invention will be given with reference to the relevant figures.

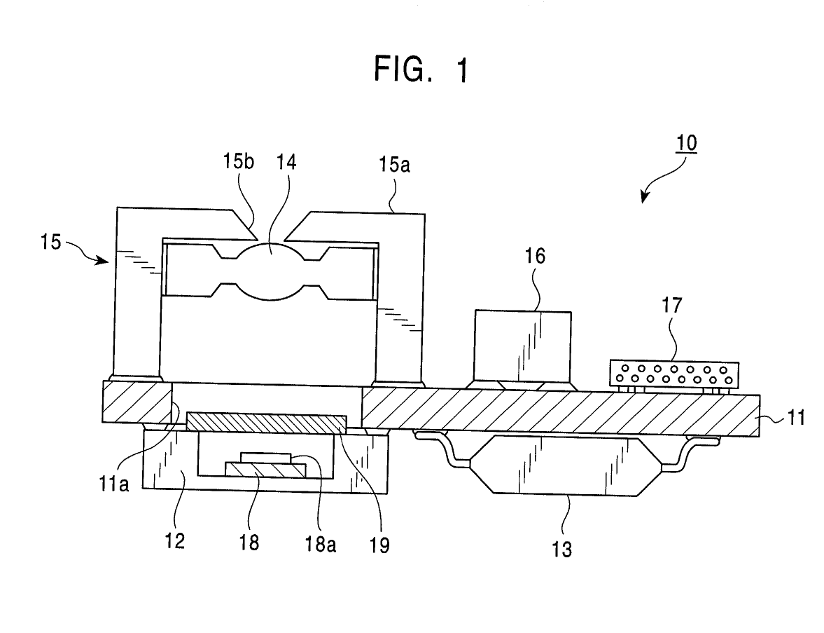

FIG. 1 is a sectional view of a solid-state image pickup device of an embodiment of the present invention.

A solid-state image pickup device 10 comprises a glass epoxy resin circuit board 11, a box-shaped ceramic or resin sensor package 12 electrically connected to the circuit board 11 at an opening side of the sensor package 12, a signal processing circuit package 13 for accommodating a signal processing circuit, an aluminum or plastic optical unit 15 including a lens barrel 15a to which a lens 14 is secured at the inner side thereof, a chip part 16 (such as a capacitor), and a connector 17 for external connection. The sensor package 12 and the signal processing circuit package 13 are provided at one surface of the circuit board 11, whereas the optical unit 15, the chip part 16, and the connector 17 are provided at the other surface of the circuit board 11.

A CMOS solid-state image pickup element 18, a light-receiving surface 18a, and a seal glass 19 are provided at the sensor package 12. The solid-state image pickup element 18 is electrically connected to the bottom portion of the sensor package 12 by die bonding using a die bond paste or the like and by wire bond connection. The light-receiving surface 18a is disposed at a side opposite to the surface of the solid-state image pickup element 18 that is connected to the sensor package 12. The seal glass 19 is used to cover an opening provided at the side of a surface of the sensor package 12 that is connected to the circuit board 11. In order to prevent foreign matter from sticking onto the solid-state image pickup element 18, the seal glass 19 is adhered to the sensor package 12 with a sealing adhesive (not shown).

An aperture 15b upon which external light falls is provided in the lens barrel 15a. The lens 14 is secured to the inner side of the aperture 15b of the lens barrel 15a in order to form the optical unit 15. The optical unit 15 is mounted so that an optical distance (from the forward surface of the lens barrel 15a to the light-receiving surface 18a), typical of the lens 14 since it is determined by the size and type of lens 14, becomes equal to a predetermined height.

The circuit board 11 includes an opening 11a. The optical unit 15, which includes an optical filter (not shown) and the lens 14 for focusing light that is incident upon the solid-state image pickup element 18, is disposed on the circuit board 11 including the opening 11a so that an optical axis of the optical unit 15 is at right angles to the circuit board 11. The sensor package 12 which accommodates the solid-state image pickup element 18 is connected to the circuit board 11 so that the light-receiving surface 18a of the accommodated solid-state image pickup element 18 is disposed on the optical axis of the optical unit 15. In other words, there is provided an optical path that allows light incident upon the lens 14 from outside the solid-state image pickup device 10 to pass through the opening 11a of the circuit board 11 and to reach the light-receiving surface 18a, which is disposed at a side opposite to the side of the circuit board 11 where the lens 14 is disposed.

In the process of producing the solid-state image pickup device 10 having the above-described structure, a solder paste printing step, a part mounting step, and a reflow step are performed in order to mount the signal processing circuit package 13, the chip part 16, and the connector 17 onto predetermined surfaces of the circuit board 11.

After the mounting of the signal processing circuit package 13, the chip part 16, the connector 17, etc. has been completed, the sensor package 12, in which the solid-state image pickup element 18 and the light-receiving surface 18a are sealed for protection from outside air by the seal glass 19, and the optical unit 15, which includes the lens barrel 15a to which the lens 14 is secured at the inner side thereof, are, by spot reflow or a manual operation, mounted to both sides of the circuit board 11, with the opening 11a of the circuit board 11 being disposed between the sensor package 12 and the optical unit 15.

In the step of mounting the sensor package 12 and the optical unit 15, first, with the light-receiving surface 18a being brought to a predetermined position, the sensor package 12 is electrically connected to one surface of the circuit board 11. Then, the position of the lens barrel 15a is determined by the position where the light-receiving surface 18a is disposed on the optical axis of the lens 14 to be accommodated and while performing a focusing operation with respect to the circuit board 11. At this time, UV curable resin, which hardens when it is irradiated with ultraviolet light, is coated on the surface of the lens barrel 15a that is connected to the circuit board 11. In addition, when determining the position, the lens barrel 15a is adjusted with a gap of 100 μm to 200 μm being left between the circuit board 11 and the joining surface of the lens barrel 15a. Lastly, with the lens barrel 15a being adjusted, the resin is irradiated with ultraviolet light and is hardened in order to secure the lens barrel 15a to the circuit board 11. By these operations, the sensor package 12, in which the solid-stage image pickup element 18 and the light-receiving surface 18a are accommodated for protection from outside air by the seal glass 19, and the optical unit 15, which includes the lens 14 that is secured to the inner portion of the lens barrel 15a, are mounted to both sides of the circuit board 11 with the opening 11a being disposed between the sensor package 12 and the optical unit 15 and with the optical path being provided.

In the solid-state image pickup device 10 having the above-described structure, light incident upon the lens 14, which is secured to the inner portion of the lens barrel 15a, from outside the solid-state image pickup device 10 passes through the opening 11a of the circuit board 11, reaches the light-receiving surface 18a of the solid-state image pickup element 18 accommodated in the sensor package 12, and is focused. Light intensity or the like is converted into an electrical signal, and the electrical signal is subjected to digital signal processing at the signal processing circuit inside the signal processing circuit package 13. Then, data is transmitted to an external device through the connector 17.

As described above, the sensor package 12, in which the solid-state image pickup element 18 and the light-receiving surface 18a are accommodated for protection from outside air by the seal glass 19, and the optical unit 15, which includes the lens 14 that is secured to the inner portion of the lens barrel 15a, are positioned and disposed on both sides of the circuit board 11 with the opening 11a being disposed between the sensor package 12 and the optical unit 15. Therefore, a path that allows light incident upon the lens 14 from outside the solid-state image pickup device 10 to pass through the opening 11a and to reach the light-receiving surface 18a is provided.

In addition, since the sensor package 12 and the optical unit 15 are disposed on both sides of the circuit board 11, even if the diameter of the lens 14 used becomes large, the optical unit 15 can be separately made large and can be connected to the circuit board 11, so that the opening 11a does not need to be made large. Therefore, even if a large lens is used, the solid-state image pickup device 10 does not become large in the horizontal direction of the circuit board 11.

Although, in the foregoing description, the signal processing circuit package which accommodates the signal processing circuit is separately connected to the circuit board, the signal processing circuit may be accommodated in the sensor package.

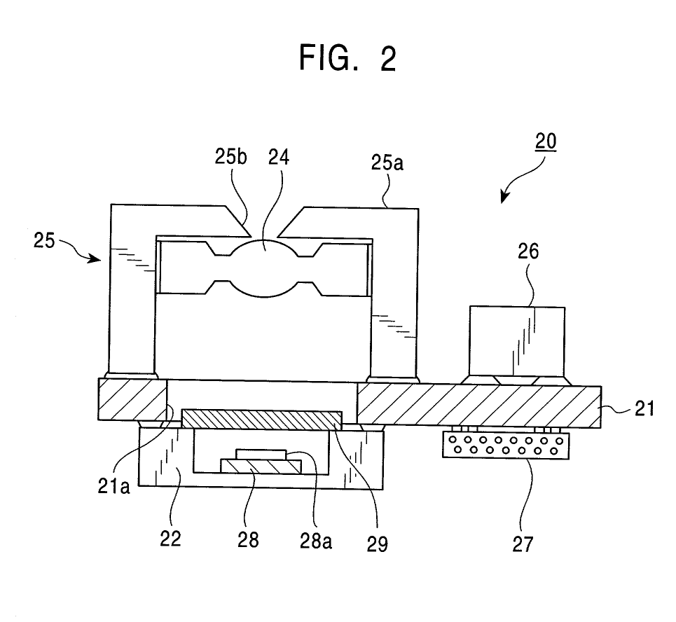

FIG. 2 is a sectional view of a solid-state image pickup element when a signal processing circuit is accommodated in a sensor package.

A solid-state image pickup device 20 comprises a glass epoxy resin circuit board 21 and a box-shaped ceramic or resin sensor package 22 electrically connected to the circuit board 21 at an opening side of the sensor package 22, an aluminum or plastic optical unit 25 including a lens barrel 25a to which a lens 24 is secured at the inner portion thereof, a chip part 26 (such as a capacitor), and a connector 27 for external connection. The sensor package 22 and the connector 27 are provided at one surface of the circuit board 21, whereas the optical unit 25 and the chip part 26 are provided at the other surface of the circuit board 21.

A CMOS solid-state image pickup element 28, a light-receiving surface 28a, a signal processing circuit (not shown), and a seal glass 29 are provided at the sensor package 22. The solid-state image pickup element 28 is electrically connected to the bottom portion of the sensor package 22 by die bonding using a die bond paste or the like and by wire bond connection. The light-receiving surface 28a is disposed at a side opposite to the surface of the solid-state image pickup element 28 that is connected to the sensor package 22. The seal glass 29 is used to cover an opening provided at the side of a surface of the sensor package 22 that is connected to the circuit board 21. In order to prevent foreign matter from sticking onto the solid-state image pickup element 28, the seal glass 29 is adhered to the sensor package 22 with a sealing adhesive (not shown).

An aperture 25b upon which external light falls is provided in the lens barrel 25a. The lens 24 is secured to the inner side of the aperture 25b of the lens barrel 25a. The optical unit 25 is mounted so that an optical distance, typical of the lens 24 since it is determined by the size and type of the lens 24, becomes equal to a predetermined height.

The circuit board 21 includes an opening 21a. The optical unit 25, which includes an optical filter (not shown) and the lens 24 for focusing light that is incident upon the solid-state image pickup element 28, is disposed on the circuit board 21 including the opening 21a so that an optical axis of the optical unit 25 is at right angles to the circuit board 21. The sensor package 22, which accommodates the solid-state image pickup element 28, is connected to the circuit board 21 so that the light-receiving surface 28a of the accommodated solid-state image pickup element 28 is disposed on the optical axis of the optical unit 25. In other words, there is provided an optical path that allows light incident upon the lens 24 from outside the solid-state image pickup device 20 to pass through the opening 21a of the circuit board 21 and to reach the light-receiving surface 28a, which is disposed at a side opposite to the side of the circuit board 21 where the lens 24 is disposed.

According to the solid-state image pickup device 20 having the above-described structure, the signal processing circuit is, along with the solid-state image pickup element 28, accommodated in the sensor package 22. Therefore, it is possible to provide space for mounting a signal processing circuit package onto the circuit board 21. By this, it is possible to mount other component parts using the provided space, so that the solid-state image pickup device 20 can be reduced in size.

Light incident upon the lens 24 from outside the solid-state image pickup device 20 passes through the opening 21a of the circuit board 21, reaches the light-receiving surface 28a of the solid-state image pickup element 28 accommodated in the sensor package 22, and is focused. The focused light is subjected to digital signal processing at the signal processing circuit. At this time, the signal processing circuit is, along with the solid-state image pickup element 28, accommodated in the sensor package 22. Therefore, it is possible to shorten the wiring distance between the solid-state image pickup element 28 and the signal processing circuit. By this, data transmission speed is increased, and even high-frequency data can be stably processed.

The signal processing circuit is accommodated in the sensor package 22. Therefore, as in the case where the signal processing circuit is accommodated in the signal processing circuit package, the signal processing circuit is kept protected from outside air.

Although, in the foregoing description, the solid-state image pickup element and the signal processing circuit are accommodated in the sensor package, a solid-state image pickup element having a signal processing function may be used.

In this case, the signal processing circuit is produced at the same time that the solid-state image pickup element is produced. By this, a signal processing function can be added to the solid-state image pickup element. Therefore, the solid-state image pickup element can be further reduced in size, and the processing speed and data transmission stability are increased.

Although, in the foregoing description, the solid-state image pickup device includes a connector so as to, through the connector, transmit data to an external device, achieve electrical power supply, be connected to ground, etc., the solid-state image pickup device may be constructed so as to be connected to an external device without a connector.

In this case, the solid-state image pickup device may be connected to an external device by, for example, forming a pad or the like, instead of a connector, on the circuit board of the solid-state image pickup device and connecting it to a substrate of the external device.

Although, in the foregoing description, a CMOS solid-state image pickup element is used, a CCD solid-state image pickup device may be used. In addition, although, from the viewpoints of costs and handling, a glass epoxy resin board is used for the circuit board, a flexible printed circuit board or a rigid flake board may be used in accordance with the purpose and application. Further, although in the foregoing description, only one chip part is used, two or more chip parts may be used, or chip parts do not have to be used.

In the above-described production process, after the signal processing circuit package, the chip part, the connector, etc., have been mounted, the sensor package including the solid-state image pickup element, the light-receiving surface, and the seal glass, and the lens barrel including the lens are mounted to the circuit board by spot reflow or by a manual operation. However, when the heat-resistance temperature of the solid-state image pickup element and the sensor package is a value that allows them to withstand the temperature in the reflow step, which is a pre-processing step, the order that the mounting step is performed in the production process can be changed, so that, for example, the reflow step can be performed after the mounting step.

In the foregoing description, the mounting arrangement of the parts on the circuit board is merely one example. Therefore, in accordance with the size, height, and number of the component parts used, the component parts may be mounted to the circuit board with the top and bottom surfaces reversed; or some chip parts may be mounted to one surface of the circuit board, and the remaining chip parts may be mounted to the other surface of the circuit board. In these cases, when relatively tall component parts are mounted to the same surface as the lens barrel, and short component parts are mounted to the surface opposite to the surface to which the lens barrel is mounted, the solid-state image pickup device can be made thin.

As can be understood from the foregoing description, a solid-state image pickup device including a circuit board with an opening, a solid-state image pickup element including a light-receiving surface, a sensor package accommodating the light-receiving surface and the solid-state image pickup element, and an optical unit including a lens is provided. The solid-state image pickup element, the sensor package, and the optical unit are provided at the circuit board. In the solid-state image pickup device, the sensor package and the optical unit are disposed so that there is provided an optical path that allows light incident upon the lens, disposed at one surface side of the circuit board, to pass the opening of the circuit board and to reach the light-receiving surface, disposed at the other surface side of the circuit board.

By accommodating the solid-state image pickup element in the sensor package, problems such as foreign matter sticking onto and condensation occurring at the light-receiving surface do not occur, so that an image pickup element which can be easily handled and which can process a high-quality image can be provided.

By mounting each component part to each surface of the circuit board, the area of the circuit board can be effectively used, and the size of the solid-state image pickup device in the horizontal direction of the circuit board can be made small.

The optical unit is mounted to the circuit board. Therefore, even if a lens with a large diameter is used, the opening of the circuit board does not need to be made large, so that the size of the lens can be changed without increasing the size of the solid-state image pickup device.

By accommodating the signal processing circuit in the sensor package, the solid-state image pickup device can be reduced in size, and the processing speed and data transmission stability can be increased.

By adding a signal processing function to the solid-state image pickup element, the solid-state image pickup device can be reduced in size, and the processing speed and data transmission stability can be increased.

What is claimed is:

1. A solid-state image pickup device comprising:
a circuit board having an opening;
a sensor package, disposed at one surface of the circuit board so that a light-receiving surface of a solid-state image pickup element opposes the opening, for sealing in the solid-state image pickup element; and
an optical unit disposed at the other surface of the circuit board so that incident light is focused on the light-receiving surface.

2. A solid-state image pickup device according to claim 1, wherein the sensor package includes a signal processing circuit for processing a signal of the solid-state image pickup element.

3. A solid-state image pickup device according to claim 1, wherein the solid-state image pickup element has a signal processing function.

4. A solid-state image pickup device according to claim 1, wherein the circuit board is connected to an external device without a connector.

5. A method of producing a solid-state image pickup device comprising the steps of:
providing a circuit board with an opening;
joining a sensor package, in which a solid-state image pickup element has been previously sealed, to one surface of the circuit board so that a light-receiving surface of the solid-state image pickup element opposes the opening; and
disposing and joining an optical unit at and to the other surface of the circuit board so that incident light is focused on the light-receiving surface.

6. A method of producing a solid-state image pickup device according to claim 5, wherein the sensor package includes a signal processing circuit for processing a signal of the solid-state image pickup element.

7. A method of producing a solid-state image pickup device according to claim 5, wherein the solid-state image pickup element has a signal processing function.

8. A method of producing a solid-state image pickup device according to claim 5, wherein the circuit board is connected to an external device without a connector.
